(19) United States
(12) Patent Application Publication
(10) Pub. No.: US 2007/0028656 A1
(43) Pub. Date: Feb. 8, 2007

(54) Lockable pull handle

(76) Inventor: Joseph Lewis Jospe, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/196,767

(22) Filed: Aug. 4, 2005

(51) Int. Cl. E05B 13/00

(52) U.S. Cl. 70/210

(57) ABSTRACT

A pull handle assembly for use with a latch mechanism and including a pivot axis, a handle and a locking mechanism. The pivot axis is fixed relative to the latch mechanism and spaced therefrom. The handle is rotatable about the pivot axis between a first position, where a finger portion of the handle engages an of a spindle of the latch mechanism, and a second position, where the finger portion is disengaged from the end of the spindle. The locking mechanism includes a blocking member movable between a locked position, where the blocking member prevents the handle from reaching the first position, and an unlocked position, where the handle is free to rotate between the first and second positions. A method of preventing the actuation of a latch mechanism of a door from one side of the door only is also provided.

### BACKGROUND OF THE INVENTION

1. Field of the Invention

The present invention relates to door latches, and more particularly surface mounted door latches of the type usually used with storm doors.

2. Background Art

Storm doors are usually provided with an inner surface mounted door latch having a pivotal latch bolt actuated by an inner horizontal pull handle. When the latch bolt is extended, a flange portion of the door frame abuts the latch bolt, thus preventing the door from being opened. On the outside, a handle grip rigidly connected to the door complete with keylock cylinder and push-button is found, with a spindle extending through the door and actuating the latch bolt upon depression of the push-button, or locking the assembly upon turning of the keylock. Such a configuration is shown in U.S. Pat. No. 3,955,839, issued May 11, 1976 to Praska et al.

Turning of the keylock cylinder blocks the latch mechanism through the action of the spindle, and the latch bolt cannot be actuated either from the inside or the outside of the door. Consequently, a person located inside must unlock the mechanism before being able to actuate the latch bolt and open the door. This is often undesirable, especially in case of emergencies when a person must be able to quickly exit through the door.

More recently, it has been known to replace the push-button and rigid handle grip on the outside of the door by a pull handle directly connected to the spindle. The handle is pivotable and actuates the latch bolt through the spindle upon being pulled by a user, allowing the door to be opened. However, such pull handles usually cannot be locked.

Accordingly, there is a need for a pull handle assembly having a locking mechanism integrated therein.

### SUMMARY OF INVENTION

It is therefore an aim of the present invention to provide a locking mechanism integrated into a pull handle.

It is also an aim of the present invention to provide a handle assembly allowing a door to be locked from one side while remaining unlocked from the other side.

Therefore, in accordance with the present invention, there is provided a pull handle assembly for use with a latch mechanism, the assembly comprising: a pivot axis fixed relative to the latch mechanism and spaced therefrom, a handle rotatable about the pivot axis, the handle being rotatable between a first position, where a finger portion of the handle engages an end of a spindle of the latch mechanism, and a second position, where the finger portion is disengaged from the end of the spindle, and a locking mechanism including a blocking member movable between a locked position, where the blocking member prevents the handle from reaching the first position, and an unlocked position, where the handle is free to rotate between the first and second positions.

Also in accordance with the present invention, there is provided a method of preventing the actuation of a latch mechanism of a door from one side of the door only, the method comprising the steps of: providing a pivot axis on a first side of the door in proximity of an end of a spindle of the latch mechanism, installing a handle to be rotatable about the pivot axis so that the handle prevents access to the end of the spindle, the handle being rotatable between a first position, where a finger portion of the handle engages the end of the spindle, and a second position, where the finger is disengaged from the end of the spindle, installing a locking mechanism including a blocking member movable between a locked position, where the blocking member prevents the handle from reaching the first position, and an unlocked position, where the handle is free to rotate between the first and second positions, and moving the blocking member to the locked position so that the handle is prevented from engaging the end of the spindle, the latch mechanism being free to be actuated from a second side of the door.

### BRIEF DESCRIPTION OF THE DRAWINGS

Reference will now be made to the accompanying drawings, showing by way of illustration a preferred embodiment of the present invention and in which:

FIG. 1 is a perspective front view of a pull handle assembly according to the present invention, with an exploded perspective view of a surface mounted latch mechanism;

FIG. 2 is an exploded, perspective, front view of the pull handle assembly of FIG. 1;

FIG. 3 is an exploded, perspective, rear view illustrating an assembling step of the handle assembly of FIG. 1;

FIG. 4 is an exploded, perspective, rear view illustrating an assembling step following the step of FIG. 3;

FIG. 5 is an exploded, perspective, rear view illustrating an assembling step following the step of FIG. 4; and

FIG. 6 is an exploded, perspective, rear view illustrating an assembling step following the step of FIG. 5.

### DESCRIPTION OF THE PREFERRED EMBODIMENTS

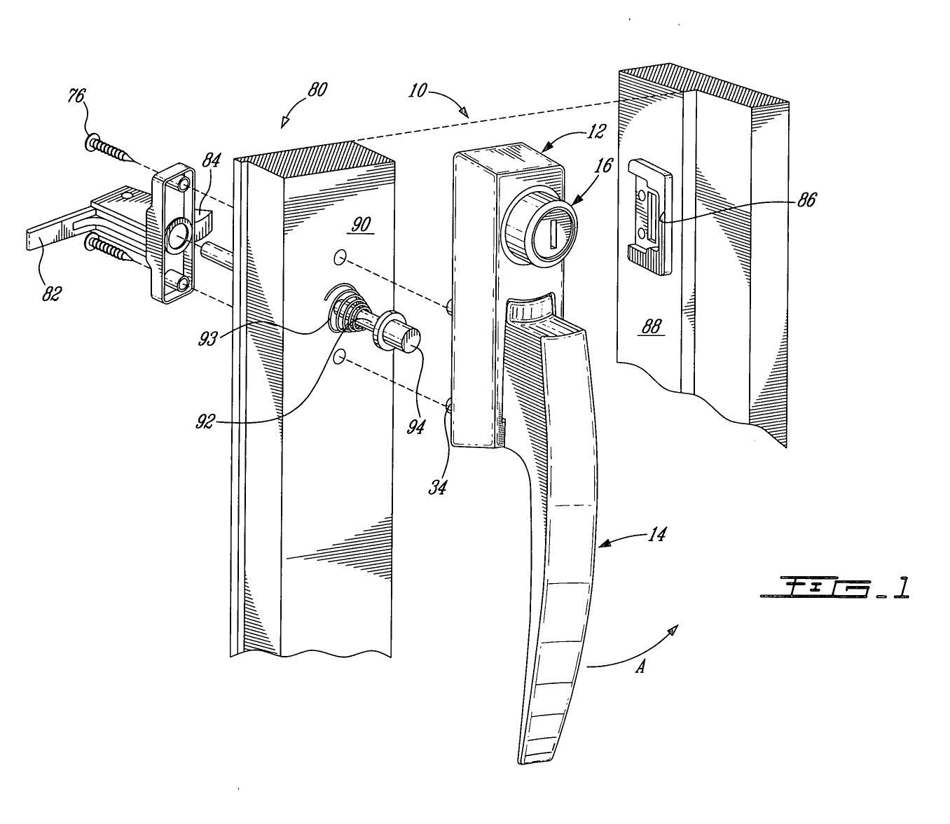

Referring to FIG. 1, a lockable pull handle assembly 10 according to a preferred embodiment of the present invention is preferably used with a surface mounted latch mechanism 80 of the type well known in the art. Such surface mounted latch mechanisms are usually used with storm doors but can be used with a variety of doors, for example doors made of aluminum or wood, with glass or screen. The surface mounted latch mechanism 80 includes a lever handle 82, on the interior side of the door 90, for actuating a pivotal latch bolt 84. With the door 90 in a closed position abutting the door frame 88, the extended latch bolt 84 abuts a flange portion 86 attached to the door frame 88 and prevents the door 90 from being opened. A spindle 92 extends through the door 90 and actuates the latch bolt 84 upon depression of an end 94 of the spindle 92, which is usually attached to a push-button (not shown). A spring 93 returns the spindle end 94 to an extended position when it is not being depressed.

In the following description, the terms “front” and “rear” are to be understood as referring to a side or surface of an element facing respectively away and toward a door when that element is mounted to the door.

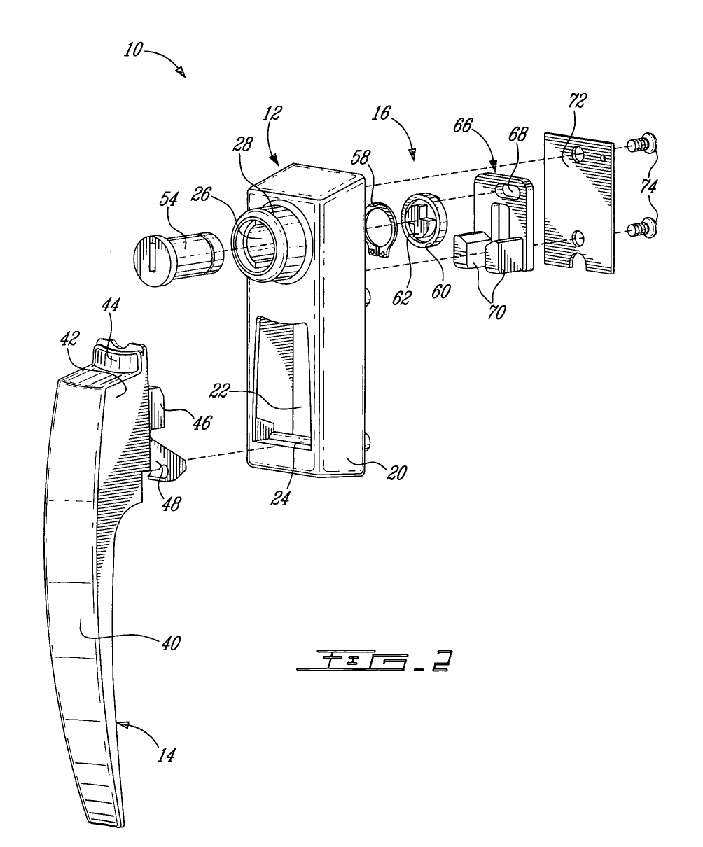

The lockable pull handle assembly 10 according to a preferred embodiment of the present invention comprises a housing 12, a pull handle 14 and a locking mechanism 16. Referring particularly to FIG. 2, the housing 12 has a rectangular-shaped body 20 which includes a rectangular opening 22 defined therethrough, from a front side to a rear side thereof. A cylindrical support 24 extends across the bottom of the rectangular opening 22. A cylindrical projection 28 is located in the upper portion of the body 20 above the rectangular opening 22 and defines a cylindrical bore 26 that also extends through the body 20 from the front side to the rear side. Referring to FIGS. 3-6, the body 20 also includes a rectangular recess 30 defined in the rear side and including therein the cylindrical bore 26. First screw holes are located over and under the cylindrical bore 26, and second screws holes are located over and under the rectangular opening 22. The body 20 is preferably symmetrical along a vertical axis.

Referring to FIG. 2, the handle 14 includes a vertical grip 40 which is connected to a head portion 42. The head portion 42 includes, along a rear side thereof, a vertical flange 44 extending upwards from the handle 14. The rear side of the head portion 42 also includes a finger portion 46 extending rearwards from the handle 14, and a hook portion 48, the purpose of which will be described herein after.

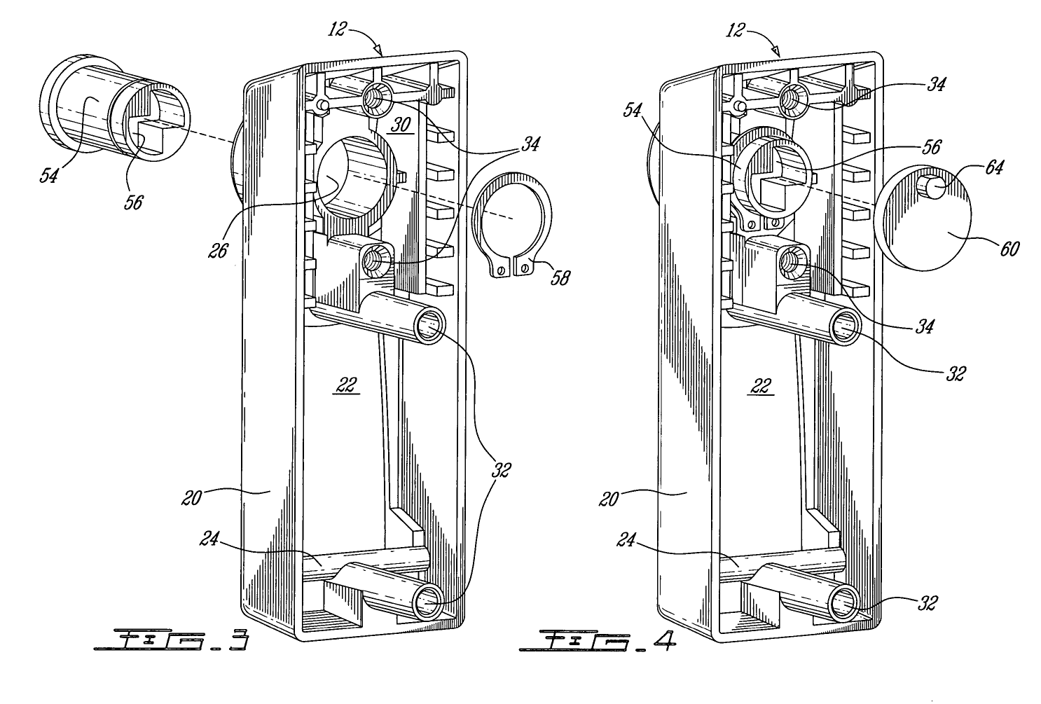

Referring to FIGS. 2-6, the locking mechanism 16 includes a lock cylinder 54, a retainer ring 58, a cam 60, a blocking member or slider 66 and a backplate 72. The lock cylinder 54 is designed to be turned only upon insertion of the correct key, as is well known in the art. A recessed portion 56 (see FIG. 3) is defined in the rear surface of the lock cylinder 54, which has a shape corresponding to a finger 62 (see FIG. 2) extending from a front surface of the cam 60, so that the cam 60 and lock cylinder 54 can be mechanically connected for rotation. The cam 60 also includes a pin 64 (see FIG. 4) extending from a rear surface thereof and offset relative to the circular center of the cam 60. The slider 66 has an inverted U-shape which is sized to fit within the body recess 30, with foot portions 70 extending frontward in the lower portion of the slider 66 and a horizontal oblong slot 68 defined in the upper portion thereof (see FIG. 2).

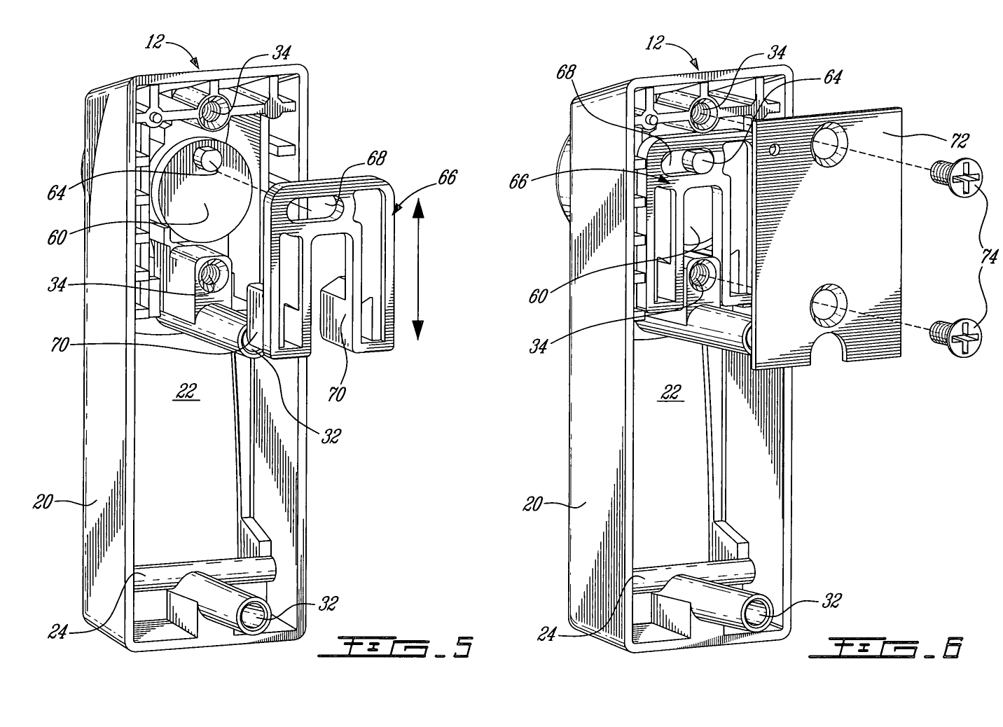

The handle assembly 10 is assembled according to the steps illustrated in FIGS. 2 to 6. Referring to FIG. 3, the lock cylinder 54 is inserted into the cylindrical bore 26 of the body 20. The retainer ring 58 is placed around the end of the lock cylinder 54 located within the body recess 30 so as to retain the lock cylinder 54 in place. Referring to FIG. 4, the finger 62 of the cam 60 is inserted into the recessed portion 56 of the lock cylinder 54. Referring to FIG. 5, the slider 66 is inserted into the body recess 30, with the pin 64 of the cam 60 being received within the oblong slot 68 of the slider 66. Referring to FIG. 6, the backplate 72 is attached to the body 20 with screws 74 threaded into the first screw holes 32 such as to retain the components of the locking mechanism 16 within the housing 12. Referring to FIG. 2, the handle 14 is connected to the housing 12 by inserting the cylindrical support 24 into the hook portion 48, thus creating a pivot axis for the handle 14. The head portion 42 of the handle 14 is located within the rectangular opening 22 of the body 20. The housing 12 is then attached to the door 90 with screws 76 threaded into the second screw holes 34, so that the end 94 of the spindle 92 is located within the recess 30, aligned with the finger portion 46 of the handle 14.

In operation, pulling forwardly on the handle 14 in direction A (see FIG. 1) will rotate the handle 14 about the pivot axis formed by the cylindrical support 24 and hook portion 48 and cause the finger portion 46 of the handle 14 to press the end 94 of the spindle 92, thereby retracting the latch bolt 84 from the flange 86 and allowing the door 90 to be opened. When the handle 14 is released, the spindle 92 returns to a rest position under the action of the spring 93, thus extending the latch bolt 84. The action of gravity and the spring 93 returns handle 14 to its initial position. The finger 46 completely covers the spindle end 94 so that the spindle end 94 cannot be depressed by other means then by pulling on the handle 14. Although the handle 14 is preferably installed so that a user will pull it along a vertical plane, it is also considered to place the handle 14 in a horizontal plane or along any other plane which is perpendicular to a plane of the door 90.

The lockable pull handle assembly 10 is locked in the following manner. Upon turning the correct key in the lock cylinder 54, the cylinder 54 rotates together with the cam 60. The pin 64 travels in the oblong slot 68 in its circular locus, forcing the slider 66 to slide down in a linear direction from an unlocked position to a locked position, where the foot portions 70 are aligned with the flange 44 of the handle 14, and located behind the rear side of the flange 44. With the slider 66 in the locked position, a pull on the handle 14 along direction A previously described will bring the flange 44 in contact with the foot portions 70, preventing the finger portion 46 from engaging the end 94 of the spindle 92 thus barring further rotation of the handle 14. Thus, with the slider 66 in the locked position, the handle 14 is prevented from actuating the latch mechanism 80.

Because the locking mechanism 16 merely prevents the handle 14 from interacting with the end 94 of the spindle 92 of the latch mechanism 80, the latch mechanism 80 is not affected by the locking mechanism 16 and thus can still be actuated from the other side of the door by depressing the lever handle 82. Therefore, the mechanism allows a user to lock a door from one side while leaving the door unlocked from the other side.

The embodiments of the invention described above are intended to be exemplary. Those skilled in the art will therefore appreciate that the foregoing description is illustrative only, and that various alternatives and modifications can be devised without departing from the spirit of the present invention. For example, it is considered to provide a blocking member having a different shape or using a rotating blocking member. Also, although the present invention has been described as being used with a surface latch mechanism, it is understood that it can be used with other types of latch mechanisms which are actuated through a push-button or similar means.

Accordingly, the present invention is intended to embrace all such alternatives, modifications and variances which fall within the scope of the appended claims.

I claim:

1. A pull handle assembly for use with a latch mechanism, the assembly comprising;
a pivot axis fixed relative to the latch mechanism and spaced therefrom;
a handle rotatable about the pivot axis, the handle being rotatable between a first position, where a finger portion of the handle engages an end of a spindle of the latch mechanism, and a second position, where the finger portion is disengaged from the end of the spindle; and
a locking mechanism including a blocking member movable between a locked position, where the blocking member prevents the handle from reaching the first position, and an unlocked position, where the handle is free to rotate between the first and second positions.

2. The pull handle assembly according to claim 1, wherein the latch mechanism and pivot axis are located on a door, with the pivot axis located on a front side of the door so that the handle is accessible by a user from the exterior in order to rotate the handle from the second to the first position.

3. The pull handle assembly according to claim 2, wherein the pull handle moves in a plane normal to a plane of the door.

4. The pull handle assembly according to claim 1, wherein the pivot axis and locking mechanism are mounted in a housing secured over the end of the spindle.

5. The pull handle assembly according to claim 4, wherein the locking mechanism includes a lock cylinder mechanically engaged with a cam, the cam having a pin slidable in an oblong slot of the blocking member, and wherein rotation of the lock cylinder causes rotation of the cam and of the pin, which in turn moves in a circular locus in the oblong slot and causes the blocking member to slide in the housing between the locked and unlocked positions.

6. The pull handle assembly according to claim 4, wherein the housing includes an opening having a cylindrical support at a bottom thereof, the handle includes a grip extending downward from a head portion, the head portion including the finger portion and a hook portion located below the finger portion and engaged with the cylindrical support to form the pivot axis such that the head portion is located within the opening, and the end of the spindle is located within the opening.

7. The pull handle assembly according to claim 1, wherein the handle includes a flange extending upwards therefrom and wherein, upon rotation of the handle from the second position towards the first position with the blocking member in the locked position, the flange comes in contact with the blocking member to stop the rotation of the handle before the finger portion can come in contact with the end of the spindle.

8. The pull handle assembly according to claim 2, wherein the door is a storm door.

9. The pull handle assembly according to claim 2, wherein the latch mechanism is a surface mounted latch mechanism mounted on a rear side of the door.

10. A method of preventing the actuation of a latch mechanism of a door from one side of the door only, the method comprising the steps of:
providing a pivot axis on a first side of the door in proximity of an end of a spindle of the latch mechanism;
installing a handle to be rotatable about the pivot axis so that the handle prevents access to the end of the spindle, the handle being rotatable between a first position, where a finger portion of the handle engages the end of the spindle, and a second position, where the finger is disengaged from the end of the spindle;
installing a locking mechanism including a blocking member movable between a locked position, where the blocking member prevents the handle from reaching the first position, and an unlocked position, where the handle is free to rotate between the first and second positions; and
moving the blocking member to the locked position so that the handle is prevented from engaging the end of the spindle, the latch mechanism being free to be actuated from a second side of the door.
